(19) United States
(12) Patent Application Publication
(10) Pub. No.: US 2003/0167199 A1
(43) Pub. Date: Sep. 4, 2003

(54) Automated workflow means and method for pension products

(76) Inventors: Karen S. Thomann, Urbandale, IA (US); Mary J. Chizek, Mason City, IA (US); Richard C. Johnson, Ankeny, IA (US); Carla K. Seiler, Madrid, IA (US); Paul N. Douglas, West Des Moines, IA (US); Thomas R. Houghton, Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/086,336

(22) Filed: Mar. 1, 2002

(51) Int. Cl. G06F 17/60

(52) U.S. Cl. 705/10

(57) ABSTRACT

The present invention discloses methods of managing workflow. One aspect of the present invention includes receiving work at a first location, determining identifying information associated with the work, building a request based on a type of the work to be completed, at least partially completing the request, and submitting the request for processing. Another aspect of the invention provides for assigning the work to workers in more than one geographical location. A further aspect of the invention provides for monitoring the location or progress of the work. Another aspect of the invention provides for monitoring of those who perform the work.

### BACKGROUND OF THE INVENTION

The present invention relates to automated workflow. In particular, the present invention relates to automated workflow in the context of administering financial products and services, including pension products.

A necessary part of administering financial products and services is processing a myriad of customer correspondence. By way of example only, retirement plan providers often process thousands of pieces of correspondence on a daily basis. Such correspondence could include a list of employee contributions, a loan application, or a cash payment. The correspondence can be received through a variety of communication channels, including paper, the Internet, or telephone. The plan provider must have some mechanism for processing the requests from customers in both an accurate and timely fashion.

Although prior art workflow systems and methods have several desirable features, they also suffer from some inherent problems. One approach is to assign a plan or case to one worker, who is responsible for overseeing all processing of customer requests relating to that plan. For instance, a defined contribution retirement plan for the ABC Corporation would be assigned to one employee, who would manage and supervise all correspondence relating to that specific retirement plan. Such a system often results in several handoffs in the workflow, which negatively affects time, cost and customer service. In addition, the workflows typically rely on paper documents, which tend to build-up at various workstations, and are difficult to track in the system. Thus, there is a need in the art for an improved electronic workflow system and methods that are more efficient, less expensive, and can track and monitor requests in the system.

Other problems exist relating to standardized processing and quality control. As an example, one worker might process an application to withdraw funds from a retirement plan differently than another worker. This lack of standardization contributes to processing errors. It is difficult to detect such errors before final processing, however. A need therefore also exists in the art for an improved workflow system with standardized processing workflows, as well as a quality control mechanism to monitor work at various points in the system.

Yet another problem in the prior art relates to unbalanced work loads in processing large volumes of customer correspondence. One plan may generate more work than another. The same holds true for customer correspondence collected in different locations; there may be more pieces of correspondence to process at one location than at others. In addition, it is often difficult to balance work loads across a particular skill level. To illustrate this point, a particular employee skill level may be required to process cash payments. Depending upon the work force to draw from at a particular geographical location, there may be a shortage of qualified workers to complete the work, while there may be an excess of qualified workers in another location to do the same work. A need therefore exists in the art for an improved workflow system and methods to balance work loads and leverage work forces in different geographical locations.

A general feature of the present invention is the provision of an improved workflow system and methods that overcome the problems and deficiencies found in the prior art.

A further feature of the present invention is the provision of an improved workflow system and methods that automatically prioritize and schedule unfinished work.

A still further feature of the present invention is the provision of standardized workflows for processing customer requests.

Another feature of the present invention is the provision of a workflow system and methods that track a piece of work during processing.

Yet another feature of the present invention is the provision of a workflow system that assigns work by skill level and priority.

Another feature of the present invention is the provision of a workflow system and methods that balance work loads and leverage work forces in multiple locations.

Another feature of the present invention is the provision of a workflow system with integration to back-office recordkeeping and accounting systems.

A still further feature of the present invention is the provision of an improved workflow system to control processing and monitor quality control.

Yet another feature of the present invention is the provision of an improved workflow system that provides reporting capabilities.

A still further feature of the present invention is an improved workflow system that allows priority to be determined in flexible ways, including by the date of receipt.

Yet another feature of the present invention is an improved workflow system that allows online images to be available to multiple locations and multiple employees at the same time.

A further feature of the present invention is an improved workflow system that allows human work to be done in advance and allows processing to be held until an appropriate time.

A still further feature of the present invention is an improved workflow system that accommodates employee absence and termination.

Another feature of the present invention is an improved workflow system that provides for management review and authorization online.

Yet another feature of the present invention is an improved workflow system that allows incorrect requests to be deleted and recreated at the examiner level.

These as well as other features and advantages of the present invention will become apparent from the following specification and claims.

### BRIEF SUMMARY OF THE INVENTION

The present invention relates to automated workflow. In particular, the present invention relates to automated workflow in the context of administering financial products and services, including pension products.

One component of the invention relates to identifying and classifying work. “Work” can be created in various ways. For example, a client can send in a completed application form which requests certain work to be performed. Similarly, a client can by telephone speak with a client service representative and request that some action is taken on the client's behalf. Other requests from clients can be received through facsimile transmissions or electronic transmissions. Thus, there are a number of different avenues through which work from clients can be received.

All work that is received is broken down into a unit called a request. Requests can be classified into different categories and each request can further be organized by a particular type or subtype. Each request is work for the system to process. This request can be a transaction for other tasks. Generally, in order to complete each request, the system requires other fields of information to be completed. Once these additional fields are completed, then the request is ready for submission to the system which will process the request.

The present invention contemplates numerous variations in the categories and subtypes of requests. By way of example only, categories can include Cash, Allocations, PERIS (Pension Electronic Reporting Information System), Plan/Contract Transfer, Life Insurance Premiums, Transfers Within a Contract, Other Additions/Deductions, Expenses/Penalties, Correspondence, Employer, Employee, Compliance Testing, Government Reporting, Quotes, Reports/Shifts/Expenses, Restarts/Reversals, DC (Defined Contribution) Reassign Customer, Balancing, Benefit Events/Withdrawals/Loans Payouts, and any other category such as may define a logical or intuitive grouping of subtypes or as may otherwise be desirable.

Similarly, within each category are a number of related subtypes. For example, the cash category can contain the following subtypes: Contribution, Holding Account, Rollover, Recordkeeping Loan Payment, Life Insurance, Transfer Funds, Negative Contribution, Non-Recordkeeping Loan Payment, Contribution Credit, Accounting Only, and Billed Expenses. It can be appreciated that a particular business can identify or create its own subtypes and categories according to the particular nature and function of its business.

One aspect of the present invention involves identifying the tasks or functions or requests that need to be performed. Thus, the system provides for reducing client contacts into collections of one or more requests. These client contacts can include mail, telephone contacts, facsimile contacts, internet contacts, and other types of contacts.

At any given time, the system of the present invention allows for a number of different requests to be present. Each request may be in various forms of completion. Each request may also have one or more uncompleted fields that should be completed prior to processing of the request.

The present invention provides for assigning the completion of the request or verification of the request to a particular location or person, group of people or other grouping. Each grouping has an associated queue in which the requests are placed. When an individual is assigned requests to complete, these requests can then be placed in their work list from the queue.

Because the work is divided into requests with each request having an associated subtype, the present invention provides for numerous advantages. Some of these advantages relate to monitoring. Because each request is created with a corresponding subtype, the progress of each request can be determined. Further, the location of each request can be determined to various degrees or resolutions. For example, it can be determined that the request is being serviced by a particular geographical location, a particular department, or a particular person.

Because work is divided into requests of various subtypes, work can be assigned in a number of different ways. One method of assigning work is based on the particular subtype of a request. Some requests may be more complicated than other requests. Not every worker may be experienced or trained in dealing with a particular type of request. Further, there is not necessarily any need to do so as some requests may occur very infrequently. According to the present invention, each worker can be assigned a skill level indicative of what types of requests the worker is to be assigned. The worker then receives requests corresponding to that particular skill level. In this manner, those who are most experienced and have the highest skill level can service the requests that are more complicated, difficult, or otherwise out of the ordinary. The more common place and simpler requests can then be serviced by workers with lower skill levels. This provides a number of advantages. First, the time of lower skilled workers is not spent trying to determine how to deal with a request they are not trained or experienced in. Further, errors caused by workers attempting to service a request they are not trained or experienced in are reduced or eliminated. In addition, the amount of training required for a worker is reduced as the beginning worker does not need to learn how to service every request but merely a subset of requests, preferably common or simple requests.

The present invention also provides for monitoring of particular workers. The number of requests which have been completed by a particular worker or a particular group of workers can be monitored. This provides management with insight into the productivity of a particular worker or a particular group of workers. In addition, this provides management with an insight into particular types of requests that are problematic or troublesome for workers, indicating that additional training may be prudent.

The Journey Into Cycle (JIC) component provides for assignment of priority and scheduling of requests. JIC processing applies both business rules and system rules to control the process of activity during cycle processing (cycle). Cycle normally occurs at night when system resources are available. The rules that are applied include both business rules and rules that embody system limitations. Examples of business rules include processing activities in the order of their effective date whenever possible. An example of a system rule is only allowing processing in the current deposit year. The system rules are of course dependent upon the particular system used.

There are two levels of rules: contract rules and member level rules. Each rule is given a priority and each rule has an associated set of categories of subtypes that it operates on. Various business rules are applied, with first the contract rules and then the member level rules. Contract rules are broader as contracts may be associated with groups of members.

Preferably the rules are given priority in an efficient manner. For example, the most important rule can be given the highest priority or else the rule most likely to be violated can be given the highest priority. For each request, each rule is applied to the contract level until either a rule is violated or else no rule is violated. Then the rules are applied to the member level until a rule is violated or else the request goes to cycle.

JIC also provides for special business rules to apply. For example, even though some rules may be violated at a member level, the request can still pass to cycle when a special rule is used to do so.

Client Service Associates (CSA) can monitor their work list to see whether requests have gone to cycle. If the requests have not gone to cycle, then they can investigate further. The specific business rules and system rules used are dependent upon a particular business and/or system. However, representative examples of business rules are now discussed. For example, one rule that would preferably have high priority would be that a particular activity is not allowed when there is a contract stop transaction request present. If a contract stop transaction request is present, then there is some reason for not processing further activity and therefore this rule can be used to make sure that no activity takes place which should not when a contract stop transaction request has been made.

An example of a system rule is that an activity must be reprocessed on restart of the system. So if there is a restart of the system, then the requests are not processed.

Another example of a business rule is that an allocation or delinquent expense must process first. This ensures that risk to the business is minimized as this business rule stops certain requests such as payments until allocations and delinquent expenses have been processed. System also uses other rules that support the general rule of money in before money out.

The tracking and management functions of the invention provide for enterprise wide reporting that can be used for a number of monitoring purposes aside from merely monitoring the location of a particular request in the workflow process. In particular, the number of requests of a particular subtype can be monitored, the geographical location of a request can be determined, the productivity of a geographic location can be determined, the productivity of a particular person can be monitored in terms of the number of requests or number of certain types of requests processed by the person and the amount of time that processing took. These monitoring functions provide a number of advantages to the business. For example, management can monitor employee productivity, can determine where too much time is being spent which may be indicative of lack of training in that area, or other trends. Further, management can view the number of requests sitting in any one of a number of queues so that it can be determined where additional workers are needed or where requests need to be transferred to a different location, or where other clogs in the workflow process are located.

Reporting can be done on three separate levels, including queue reports, progress reports, and personnel reports. The queue reports allow management to determine where the work is. For example, is the work currently being performed, is the work currently being checked, or is the work currently being examined. Further, management can determine whether the work is delayed for a particular reason, whether it is waiting for management authorization, or whether it is within the JIC system. Further, queue reports allow for a snapshot of trends to be viewed including historical trends. This allows management to improve resource allocation so they can allocate workers accordingly, such as by skill level.

Progress reports are used to determine how workflow is progressing based on time. The progress reports can be used to track high visibility or high volume requests or other requests that are given special significance. This allows management to monitor the amount of time these requests are taking. It is important that some of these requests be performed quickly. Examples of requests with special importance include requests for clients that are given priority or requests that if not performed timely risk financial loss for the business.

Personnel reporting provides for a means of monitoring the productivity of personnel. For example, it could be used to determine the number of requests per hour of a worker or an examiner. It can show the number of requests touched by that person, the amount of time spent by the person on each request, the number of errors made by that person, and the number of times that work has been returned to that person. Because this information is available, timing standards can be created for personnel to comply with. This allows management to set minimum competency levels or to provide compensation based on production. Further, these personnel reports may be used as a management tool to identify those areas where additional training is needed, such as where a number of similarly positioned people are making the same types of errors or are spending too much time on a specific type of request. In cases such as this, then management may determine that workers are receiving inadequate training and their productivity could be improved in these areas through additional training.

### BRIEF DESCRIPTION OF THE DRAWINGS

The present invention is illustrated by way of example and not limitation in the accompanying drawings, and in which:

FIG. 1 is a diagram of a method according to the present invention.

FIG. 2 is a system diagram according to the present invention.

FIG. 3 is a screen display of a “work in process summary” of requests according to the present invention.

FIG. 4 is a screen display of a “product detail” summary of requests according to the present invention.

FIG. 5 is a screen display of a “global worker summary” according to the present invention.

FIG. 6 is a screen display of a “division report” according to the present invention.

FIGS. 7A and 7B are screen displays of a “team by member report” according to the present invention.

### DETAILED DESCRIPTION OF THE INVENTION

The present invention will be described as it applies to a preferred embodiment. It is not intended that the present invention be limited to the described embodiment. It is intended that the invention cover all modifications and alternatives which may be included within the spirit and broad scope of the invention. In particular, the preferred embodiment described relates to administering a defined contribution retirement plan such as a 401 (K) plan. The present invention is in no way so limited, as it encompasses the provision of other types of products and services.

Further, the present invention is described primarily from a business standpoint in order to fully facilitate making and using the invention. The methods herein described may use various conventional computer systems, telephony devices, and other business equipment. Such devices are well known and can be selected for any number of reasons unrelated to the invention. Further, any programming or configuration of such devices will depend upon the particular equipment used by the particular business and is properly delegated to information technology staff persons, outside consultants or other similarly situated persons. Thus any preference for any specific hardware and software implementation over others will vary from financial provider to financial provider.

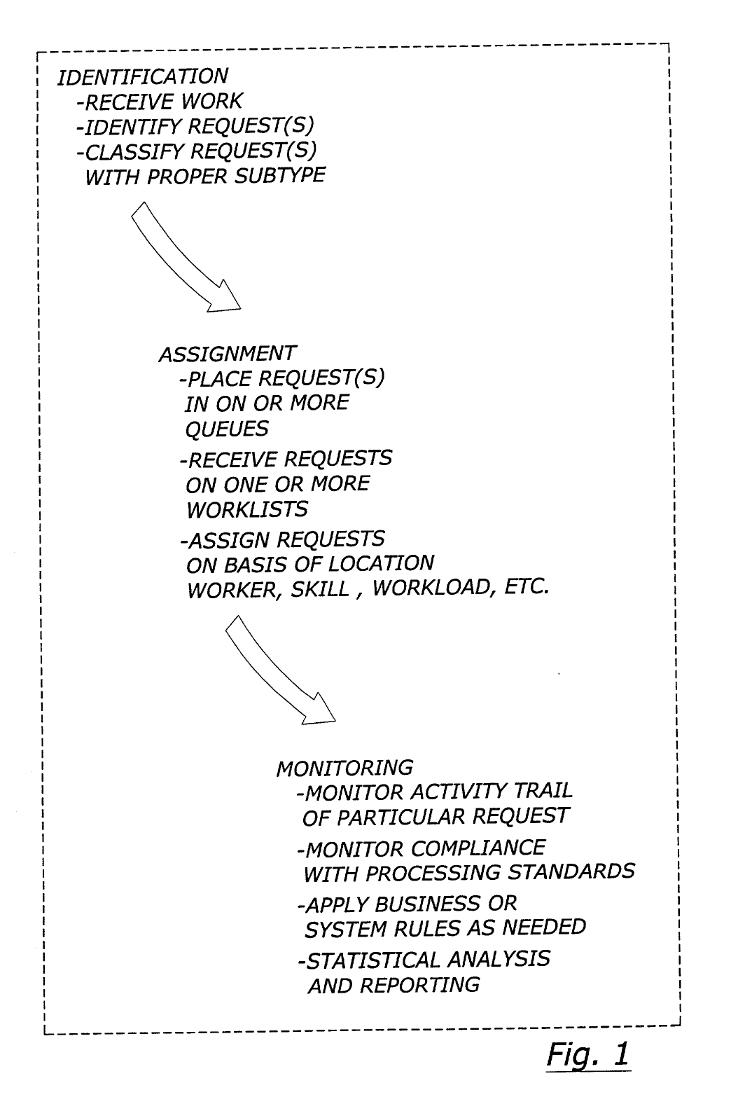

FIG. 1 is a diagram providing an overview of a method according to the present invention. A first step in the method involves identification of work to be performed. In the context of a preferred embodiment, the work to be performed is often based on a request made by a client relating to a financial service or product. A request can be created in various ways. For example, a client can send in a completed application form which requests certain work to be performed. Similarly, a client can call in and speak with a client service representative and request that some action is taken on the client's behalf. Other requests from clients can be received through facsimile transmissions or electronic transmissions. Thus, there are a number of different avenues through which requests from clients can be received, each request requiring action on the part of the financial services provider.

Once correspondence is received or work is otherwise received, the financial services provider identifies requests. Each request is an instruction authorizing and/or requiring the financial services provider to perform a particular action. Requests can be classified into different categories and each request can further be organized by a particular type or subtype. This request can be a transaction or other task. The particular request can be manually created based on correspondence received by a client. This identification and creation process is referred to as “building” the request. In addition to being manually built, the request can be auto-built by the system. Examples of auto-built requests include requests that a client makes electronically or using an automated voice response system. These types of auto-built requests are built without the need for human interaction or review as all information that is required to identify the client or account and the type of request is put in a usable electronic form. The source of information from which auto-built requests are made may depend in part of what hardware and software systems and resources a financial provider has available. For example, those financial providers who provide their clients with Internet access to account information and maintenance preferably provide for eliciting the information required to auto-build the associated requests over the Internet. The present invention does not require any specific hardware and/or software platform. Further, the request does not necessarily need to be created only in direct response to communication with a client, but can be built for other reasons which may depend upon the particular request.

Each subtype of request has its own requirements for information that will be needed in order to service the request. Once the subtype has been identified, it is known what information is needed in order to service the request. Associating the proper information needed for a request with the request is referred to as “completing” the request. The present invention permits the request to be autocompleted when the information required to complete the request is readily available to the automated system.

If information needed to complete the request is not available, the next step is the assignment of the request. The request is assigned to a worker who can complete the request and prepare it for processing by providing the information required for the particular subtype. The present invention provides a great deal of flexibility in assigning the requests. For example, the request is automatically assigned to a queue. From a queue, the request can be reassigned to a worker. The request will then fall into the get next processing. The present invention allows queues to be selected in various ways to improve efficiency, decrease the amount of time that it takes to service a request, increase worker productivity, or otherwise provide efficient or desirable assignment.

For example, the completion of various requests can be assigned based upon the geographic location of the workers. If it is known that at a first location there is a high workload and at a second location there is a low workload, workers at the second location can be assigned to work the queues of the first location. The completion of various requests can also be assigned to workers based on the subtype of the requests. Each worker is assigned a skill level related to the subtypes or complexity of requests that the worker can complete. This provides a number of benefits. First, not all workers need to be trained to complete all subtypes of requests. This reduces the amount of time and expense associated with training workers. Second, workers are not assigned requests having subtypes that the workers are not trained to handle, thus their productivity is not hampered. Third, by assigning requests based on skill level, fewer errors are created in the completion process.

Another step of the present invention involves monitoring. Monitoring serves various business functions. Such functions include ensuring that requests are properly built, ensuring that requests are properly completed, ensuring that requests are timely built, and ensuring that requests are timely completed. Further, monitoring provides the opportunity to monitor the activity trail of a particular request so that the precise status of the request can be determined at any time. In addition to monitoring requests, the present invention provides for monitoring the work of workers who are building or completing the requests. This provides management with objective information concerning the productivity of workers, including the amount of work and quality of work being performed. The present invention provides for statistical analysis and reporting. This information can be monitored on an individual, group, or global level. Rational and well-supported business decisions can be made on the basis of this information. For example, it can be determined that more training is needed in a particular area or by a particular person.

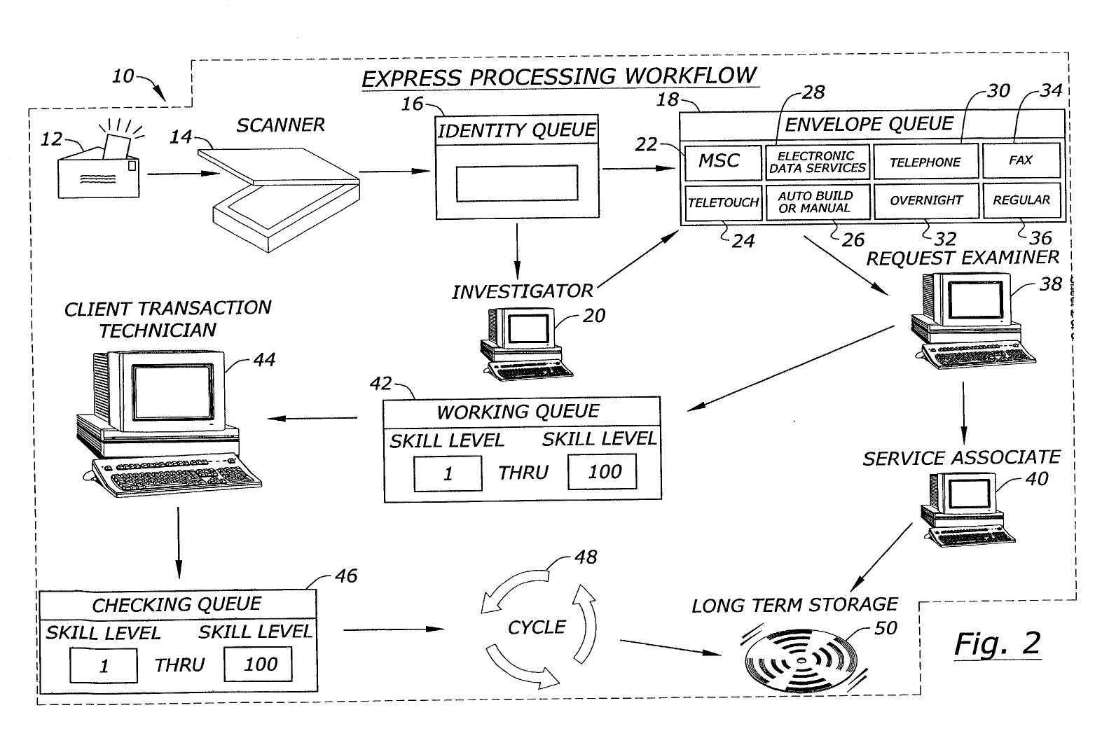

FIG. 2 illustrates the processing workflow of one embodiment 10 according to the present invention. Client correspondence is received and prepared for scanning at step 12. It is preferred that a special mailing address is provided for correspondence relating to each particular financial product or service, so as to keep such correspondence separated from other business correspondence and other financial products or services, thereby expediting the process of entering client correspondence into the system.

Correspondence from clients may take various forms, including, but not limited to, regular mail, overnight mail, electronic mail (e-mail) and electronic documents. Client requests may also be initiated by telephone, automated voice response system or other means. For correspondence received in hard copy format, it is handled by operators and imaged with a document scanner in step 14. Depending upon the scanner used, this may include converting the original documents to 8½×11 inch paper for scanning. In addition, separator sheets are normally placed between different envelopes of correspondence to distinguish one set of correspondence from another once scanned into the system.

At step 14 the scanner converts the client correspondence from hard copy to a digital format, storing the images for a particular piece of correspondence in an electronic envelope. The present invention provides for any number of scanners to be used as may be appropriate to a particular business and implementation of the invention. Using electronic envelopes to organize the correspondence helps ensure the integrity of the information scanned into the system while providing an intuitive organizational structure.

It is preferred that the scanner imprint the location of the original documents on the digital images should the originals need to be located for future reference. It is also preferred that the correspondence or mail be prioritized for scanning into the system. For example, overnight mail, facsimiles and cash payments could be given priority over other types of correspondence. Original paper correspondence can then be saved for a given time period after which it may be discarded. For documents received in the same manner, preferably documents are prioritized by date of receipt.

The electronic envelopes of scanned documents are stored in an identify queue at step 16. At this point, an operator reviews the images to find a contract number and contract name for each electronic envelope. In particular, the operator issues a command to the system to receive the next electronic envelope in the identify queue. The operator will then enter a contract number for each electronic envelope, verifying that the contract number and contract name match. The contract number entered by the operator is maintained as identifying information for the electronic envelope as it proceeds through the system.

It can be appreciated that once the correspondence is scanned into the system at step 14, operators can identify electronic envelopes at step 16 from wherever they obtain access to the system. As such, overflow work scanned in at one location can be identified by operators in another location. For instance, mail received in Spokane, Wash. could be identified in Des Moines, Iowa by an operator with access to the system. This provides advantages in managing the flow of work as identification work can be assigned to any number of locations for a variety of reasons independent of where the actual paper correspondence is received.

Once a piece of customer correspondence is scanned into the system, it is moved to a storage area. In most instances, long-term image storage allows the hard copies to be disposed of permanently. The online images are available to all locations and employees at the same time, providing a significant advantage over relying upon paper documents.

If the operator encounters any problems identifying the electronic envelope, the electronic envelope is routed to a group of investigators at step 20 who will make the necessary inquiries to identify the electronic envelope. For example, a contract number may not be visible on the scanned images. In this instance, further investigation will be necessary to determine and verify the contract number and contract name. Once an operator has finished identifying the electronic envelope, the operator issues a command to the system to receive the next electronic envelope in the identity queue. This allows the operator to continuously receive a stream of work.

After the electronic envelope has been identified at step 16, it is routed to an envelope queue at step 18. The envelope queue contains electronic envelopes of information obtained through various means, including customer correspondence received by facsimile, overnight mail 32, regular mail 36, telephone 30, TELETOUCH® 24 and electronic data services 28. In addition, the plan provider can create an electronic envelope in the system to generate a request and a transaction. Also, there may be various electronic envelopes that do not require scanning documents and identifying digital images in steps 12 and 14. Such electronic envelopes are referred to as “auto-built” requests. As an example of an auto-built request, an employer may submit a list of employee contributions to a 401 (k) plan via the Internet. In this case, there are no hard copies of documents to scan into the system. The request has been automatically built and in most instances automatically completed. If the request cannot be automatically completed, it still bypasses the identify and examiner role and goes directly to the worker queue.

At step 38 electronic envelopes in the envelope queue are routed to a request examiner. The request examiner executes a “get next” command to the system to retrieve an electronic envelope from the queue. It is preferred that the electronic envelopes be routed to the request examiners based upon priority. In the preferred embodiment, the relative priority of an electronic envelope in the queue corresponds to the medium from which it arrived (e.g., fax, fax server, regular mail). The request examiner executes a “get next” command to retrieve the electronic envelope having the highest priority in the queue. Although the terminology “get next” as used here is consistent with a particular implementation of the applicants, it will be appreciated that any number of commands or instructions may be used that allow a request examiner to indicate that the request examiner is ready for the next item of work. Further, the present invention also contemplates that the next item of work can otherwise automatically or manually be directed to the request examiner.

In some applications, it may be advantageous to assign one or more request examiners to a particular queue. For example, all customer requests from a particular remote location may be stored in a special queue and routed to a particular set of request examiners most familiar with specific matters applicable to the location. Further, the system allows for usercoding for employee absence or termination so that work is not directed to an employee that is not available for service.

At step 38 the request examiner reviews the contents of the electronic envelope to identify the subtype of request involved so that the request examiner can create the appropriate request. The request examiner places the documents in the electronic envelope in folders, one folder per request or task. This provides further organization of what is contained within an electronic envelope so that a particular document or page of a document which is later needed can be more easily found and in less time. Also, the request examiner identifies incorrect requests. Incorrect requests can be deleted and recreated at the examiner level saving the time to rescan and identify the image.

A typical 401 (k) administration system can have hundreds of different types of requests or tasks. It is the request examiner's responsibility to identify the request appropriate to the client's correspondence. A complete list of subtypes is available to the examiner. The list is preferably indexed by a category type and subtypes so that a request examiner can quickly identify the proper subtype to be used to create a request. It is preferred that a complete manual of requests be made available to the request examiners on-line, such as in FOLIOVIEWS®. This enables the request examiner to view detailed information regarding each request, including the steps or procedures required to complete the request.

The examiner can associate a comment with the request. In some instances, it may be helpful to advise a record specialist concerning an unusual aspect of the request that the request examiner has noticed. The comments provided by the request examiner stay with the request throughout the system. An activity trail or history is also maintained for each request. The activity trail is a log of information regarding who has handled the request or electronic envelope and.

Once the request examiner has created the request, it is stored in a working queue of current requests at step 42. Although only one queue is shown, the present invention contemplates that any number of queues may be used, including queues which are subsets of other queues. Queues can be created based on particular subtypes of a request, the skill level associated with the request, the geographical location of where the subtype should be processed as well as other reasons.

The present invention also contemplates that there may be other problems that preclude a request examiner from building the appropriate request. Where such a problem arises, instead of building an improper or erroneous request, such a problem can be delegated to a client service associate 40 who can then create a service request. Service requests are routed back to examiners to determine the appropriate subtype for processing.

In step 44, the client transaction technician executes a “get next” command to the system to receive a request. In response to a “get next” command, the system assigns to the next available client transaction technician a request based upon the relative priority of the requests in the working queue and the skill level of the client transaction technician. Although the terminology “get next” as used here is consistent with a particular implementation of the applicants, it will be appreciated that any number of commands or instructions may be used that allow a client transaction technician to indicate that the client transaction technician is ready for the next item of work. Further, the present invention also contemplates that the next item of work can otherwise automatically or manually be directed to the client transaction technician.

At step 44 the client transaction technician works the request through to completion. It is the responsibility of the client transaction technician to perform the steps necessary to complete the request. This often times includes obtaining and entering data necessary for completing a request.

In its simplest form, the present invention implements a one-step workflow. After working a request through to completion, the client transaction technician simply executes another “get next” command to retrieve another request. It can be appreciated that such a system eliminates the problems associated with holding work and allowing unfinished work to accumulate in certain areas. Further, the present invention balances work loads across a particular skill level, as a client transaction technician is not dedicated to a particular product or service but can take work relating to multiple products and services. Still further yet, the present invention takes advantage of a global work force, leveraging pools of workers in different locations. So long as the various work forces are connected to the computer network, they can complete requests.

Upon completion of the request, the request is optionally routed to a checking queue at step 46 if the worker or another elected to have the request checked at step 38 or else if the request has randomly or otherwise been selected or designated for checking. If the completed request is not to be checked, it is sent directly to a holding place to await cycle processing at step 48. Completed requests in the checking queue are reviewed prior to cycle processing. From step 46 the completed requests journey into cycle processing at step 48. Any transaction requiring pricing information is normally done in a batch cycle after the close of business once the share prices of mutual funds and other financial instruments have been updated. It is to be appreciated that requests doe not necessarily need to be processed immediately. Thus, for example, those requests that have been manually built can be held until the proper time for processing.

The Journey Into Cycle (JIC) component provides for assignment of priority and scheduling of requests. JIC processing applies both business rules and system rules to control the process of activity during cycle processing (cycle). Cycle normally occurs at night when system resources are available. The rules that are applied include both business rules and rules that embody system limitations. Examples of business rules include processing activities in the order of their effective date whenever possible. An example of a system rule is only allowing processing in the current deposit year. The system rules are of course dependent upon the particular system used.

There are two levels of rules: contract rules and member level rules. Each rule is given a priority and each rule has an associated set of categories of subtypes that it operates on. Various business rules are applied, with first the contract rules and then the member level rules. Contract rules are broader as contracts may be associated with groups of members.

Preferably the rules are given priority in an efficient manner. For example the most important rule can be given the highest priority or else the rule most likely to be violated can be given the highest priority. For each request, each rule is applied to the contract level until either a rule is violated or else no rule is violated. Then the rules are applied to the member level until a rule is violated or else the request goes to cycle.

JIC also provides for special business rules to apply. For example, even though some rules may be violated at a member level, the request can still pass to cycle when a special rule is used to do so. In particular, a pension plan may have a number of different members. It is desirable not to allow an incomplete request of one member to preclude processing of requests that affect the pension plan as a whole. Therefore, even though the request of the one member may violate certain member rules and require further action on the part of a client service associate or other, the processing of such a request does not delay processing of the pension plan as a whole. In this and other instances it may be less time consuming and less costly to go ahead and process the request made at the member level, even though it does not comply with all member rules, instead of delaying the processing of requests related to the contract to which the member belongs.

After completing the cycle or batch processing at step 48, the request and associated electronic documents are maintained for 60 days in short-term storage before moving to a long-term digital storage location (step 50), eliminating the need to retain paper copies.

The present invention also provides for the case of where a request has been submitted to cycle, but an exception is taken. This can occur for various reasons, such as incomplete information. If this occurs, then exception messages are created and returned so that a worker or another can review to see what steps need to be taken, if any, to ensure that the request has been fully processed. In certain instances, under particular business or systems rules, information can be processed even though it may not be fully complete.

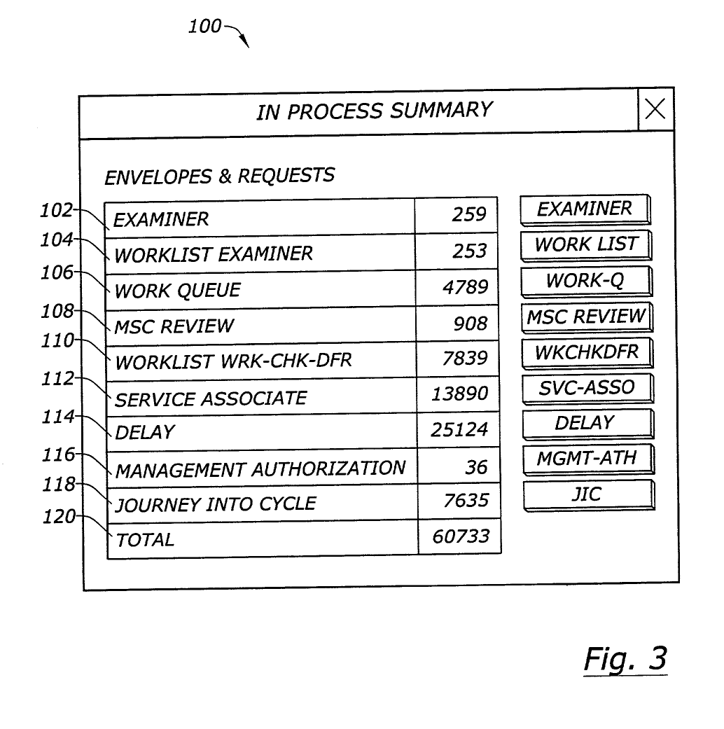

The present invention provides a number of advantages relating to monitoring and controlling workflow. For example, FIG. 3 is a screen display illustrating how the number of envelopes and requests in process can be summarized. This and other screen displays are merely representative and the invention does not require any particular graphical user interface design. A particular display may in part depend upon the particular hardware and software systems used in accordance with the invention. The report shown provides important business information that allows for more informed business decisions to be made. In FIG. 3, the number of requests at various stages in the workflow process are shown. For example, the number of requests associated with an examiner 102, a worklist examiner 104, a work queue 106, member service center review 108, a worklist work-check-defer 110, service associate 112, delay 114, management authorization 116, and journey into cycle 118 are shown. In addition, a total 120 is also provided.

Thus, based on monitoring of these totals over time, meaningful information is provided. In particular, it can be determined whether there are too many requests in one particular place. For example, if there are too many requests in the work-check-defer worklists, then perhaps additional training may be required in order to reduce the number of requests that client transaction technicians want checked or deferred. Similarly, these numbers over time may mean that additional personnel is necessary in order to reduce the size of these queues so that work can be processed in a more timely fashion. This monitoring of totals and other types of monitoring can be performed online by management.

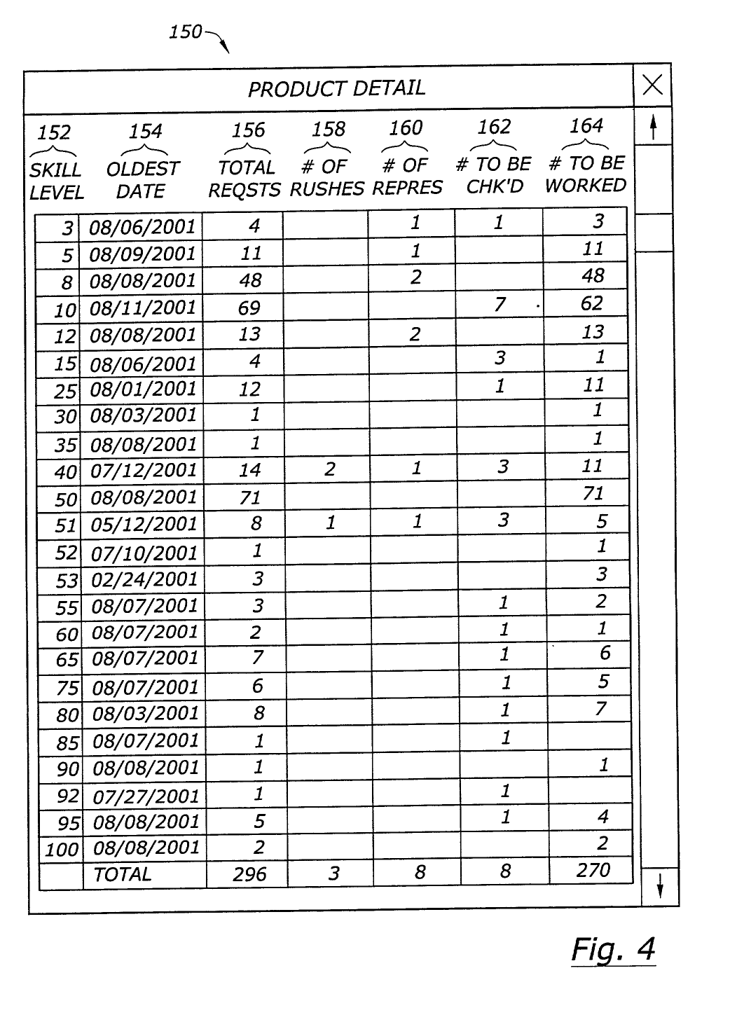

For each of these different totals, a business manager or other person may drill down on the information to receive more detailed reports and/or analysis. FIG. 4 provides an example of a product detail report 150. In this particular report, the skill level 152 associated with a particular request is shown along with the oldest date 154 for that skill level of request. This provides a business manager with information concerning the maximum delay associated with each particular skill level of requests. In addition, the total number of requests 156 are shown for each skill level, the number of requests that are rushes 158, the number of requests that have been checked and returned 160, the number of requests that are to be checked 162, and the number of requests to be worked 164.

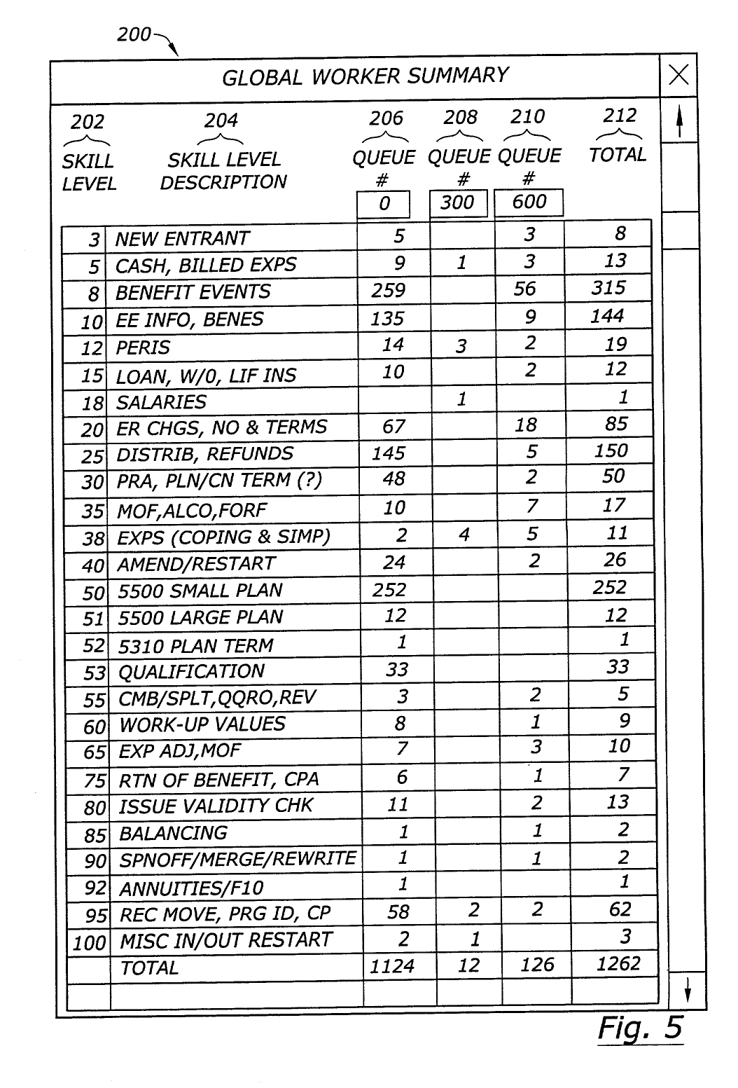

FIG. 5 is a display showing another type of report. In FIG. 5, a global worker summary 150 is shown. This summary 150 provides the number of requests associated with each of a plurality of queues. In addition, the skill level of requests 202 is shown along with a skill level description 204. A total across all queues 212 is also provided. A business manager can review this report for workflow purposes and determine that one queue has too much work and then divert workers to other queues. In this manner, a business manager can ensure that work is progressing in an efficient fashion.

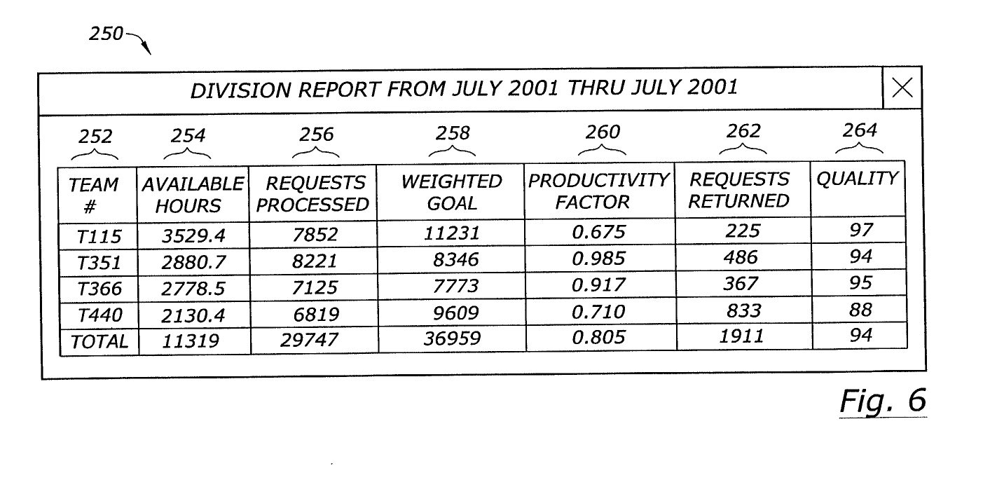

FIG. 6 is a display showing a division report 250. According to FIG. 6, statistics are shown for a number of different teams 252. Associated information includes the number of available hours 254 attributed to the team, the number of requests processed 256, the weighted goal 258 for the team, the productivity factor 260 (ratio of requests processed to the weighted goal), the number of requests returned 262, and a quality rating 264 (percentage of requests processed that were not returned).

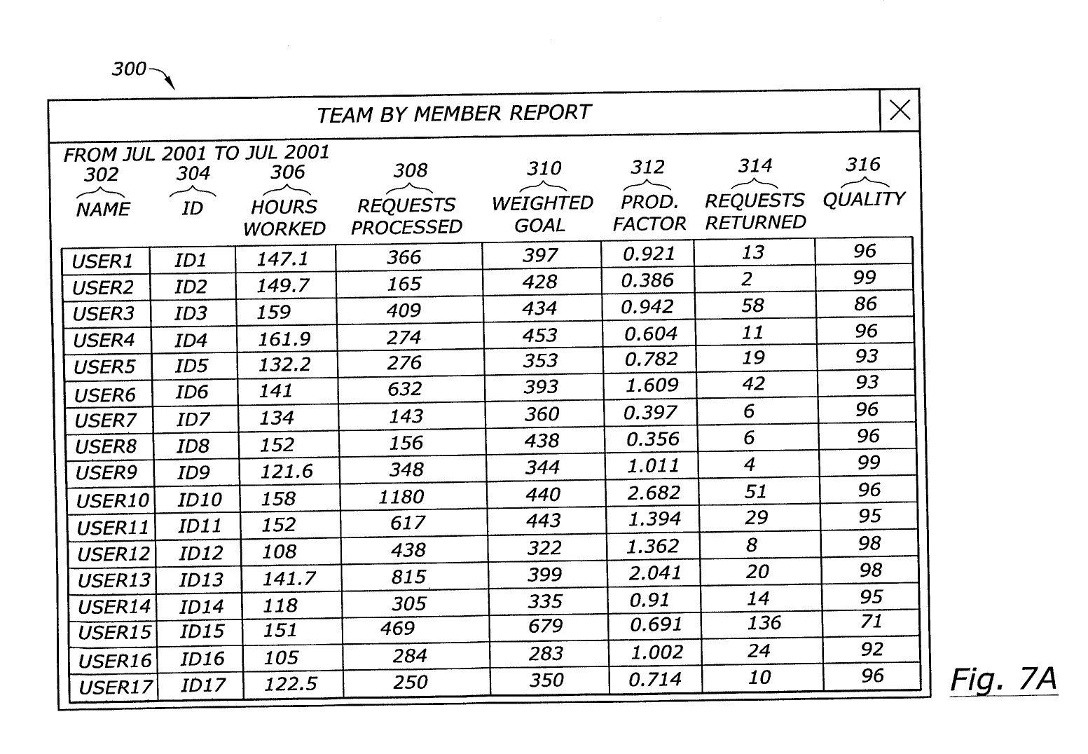

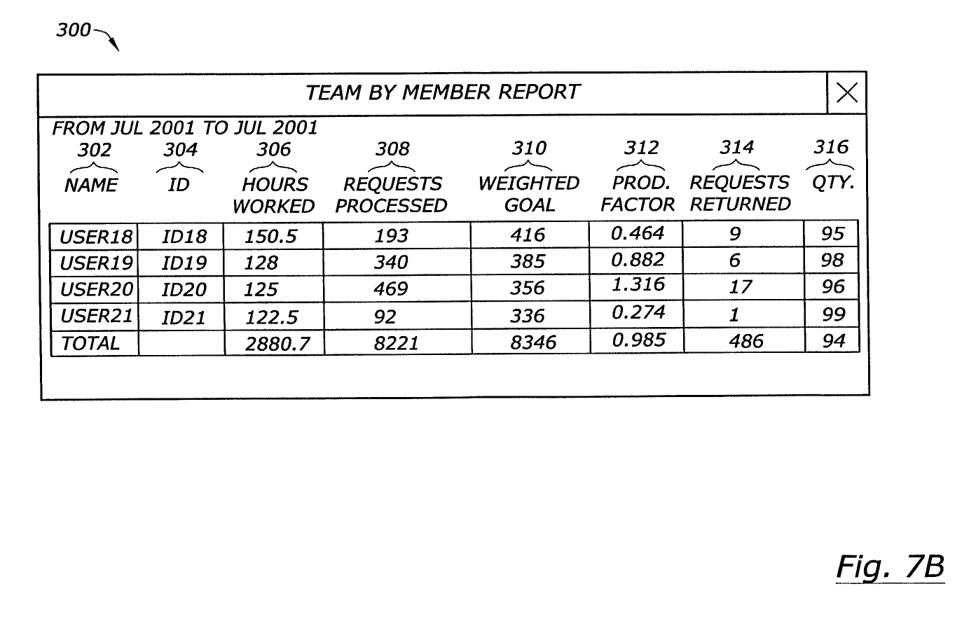

FIGS. 7A and 7B provide a display showing a team by member report 300. This type of report provides for reporting on each member of a team. This information shown includes the name 302 of each member, the ID 304 associated with the member, the number of hours worked 306 by each member, the number of requests processed 308 by each member, the weighted goal 310 for each member, the productivity factor 312 for each member, the requests returned 314 for each member and the quality 316 for each member.

The reports shown are merely representative and illustrative. The present invention provides for numerous variations in the number and types of reports as may be appropriate for a particular type of monitoring or as may be useful in supporting a particular business decision. It will be appreciated that any number of other reports in any number of formats can be created in accordance with the teachings of the present invention.

For purposes of example, a particular request is described from start to finish. This particular request is a Contribution subtype within the Cash category. Further, this subtype has a request type, skill level, and a priority code. Information concerning this subtype is available to examiners, technicians, service associates, and others, preferably in an online format.

This particular subtype is of the Accounting/Record-keeping type. A skill level of 5 on a scale of 0 to 100 is associated with this subtype. There is a priority code of 20 on a scale of 0 to 100. When online reports perform tabulation or calculations, each item within the request is counted separately.

In addition, a description of the subtype is provided. For example, the contribution subtype can be described as being used for crediting cash to members' accounts including the following: new money, comparability plan allocations, forfeiture allocations, profit sharing allocations, transfer/takeover allocations. In addition, information concerning whether the request can be auto-built and auto-completed is provided. Further information concerning who can build a request of that subtype is provided, including a request examiner, worker, worker with reprocess ability, service associates and the member service center.

Another subtype of request is a loan quote. The associated request category and type is quotes. The associated skill level is 0, a minimal skill level. Service associates complete these requests since the skill level is 0 and no system entries are required. There is no priority code for this request subtype. Online reports count the number of loan quote requests in tabulation and statistical analysis.

The loan quote subtype of request provides instructions for processing loans to the client service associate. Request examiners, workers, and worked with reprocess ability can build the request. A service associate can not build this request.

A request examiner will receive a letter, fax, phone memo or service request indicating that a client seeks a loan quote. The request examiner builds the corresponding request. The service associate completes the fields and then provides the information to the client.

One having the benefit of this disclosure will appreciate that any number of types (and subtypes) of requests can be used, each having a particular procedure. The present invention is not limited to a particular subtype or procedure. Instead, the invention contemplates that numerous variations may be used as may be appropriate to a particular business use.

Thus, an automated workflow invention has been disclosed. In the preceding detailed description, the invention is described with reference to a specific exemplary embodiment thereof. Various modifications and changes may be made hereto without departing from the broader spirit and scope of the invention as set forth in the claims. The specification and drawings are, accordingly, to be regarded in an illustrative rather than a restrictive sense. The invention is to be limited only by the claims appended hereto.

What is claimed is:

1. A method of managing workflow comprising:
receiving work at a first location;
determining identifying information associated with the work;
building a request based on a type of the work to be completed;
at least partially completing the request; and
submitting the request for processing.

2. The method of claim 1 wherein the work is selected from the set comprising: work received via mail, work received via electronic data services, work received via telephone, work received via facsimile, work received via overnight mail, and work received via private courier.

3. The method of claim 1 wherein the work is received in paper form.

4. The method of claim 3 further comprising imaging the paper form of the work to create a digital representation of the work.

5. The method of claim 4 further comprising associating the identifying information with the digital representation of the work.

6. The method of claim 4 further comprising placing the digital representation of the work in a digital envelope.

7. The method of claim 1 wherein the step of identifying client and contract information associated with the work is performed manually.

8. The method of claim 7 further comprising assigning the step of determining identifying information to a worker.

9. The method of claim 1 wherein the step of determining identifying information associated with the work is performed automatically.

10. The method of claim 1 wherein the step of determining identifying information associated with the work is performed at a second location, the first location geographically removed from the second location.

11. The method of claim 1 wherein the step of determining identifying information associated with the work includes determining a client identifier.

12. The method of claim 1 wherein the step of determining identifying information associated with the work includes determining an account identifier.

13. The method of claim 1 wherein the step of determining identifying information associated with the work includes determining a client name and a contract identifier.

14. The method of claim 1 wherein the step of building a request is performed automatically.

15. The method of claim 1 wherein the step of building a request is performed manually.

16. The method of claim 15 further comprising assigning the step of building a request to an examiner.

17. The method of claim 1 wherein the step of building a request is performed at a second location, the second location geographically removed from the first location.

18. The method of claim 1 wherein the step of at least partially completing the request is performed automatically.

19. The method of claim 1 wherein the step of at least partially completing the request is performed manually.

20. The method of 19 further comprising assigning the step of at least partially completing the request to a client transaction technician.

21. The method of claim 1 wherein the step of at least partially completing the request is performed at a second location, the second location geographically removed from the first location.

22. The method of claim 19 wherein the step of at least partially completing the request is fully completing the request.

23. The method of claim 1 further comprising prioritizing the work received.

24. The method of claim 23 further comprising prioritizing the work received at least partially by a manner in which the work is received.

25. The method of claim 1 further comprising placing the work received into an identity queue.

26. The method of claim 1 further comprising placing the work identified into a queue.

27. The method of claim 1 further comprising placing the request into a queue.

28. The method of claim 1 further comprising checking the at least partially completed request.

29. The method of claim 1 further comprising assigning a skill level to the request based on the type of work to be completed.

30. The method of claim 29 assigning the step of at least partially completing the request to a worker based on the skill level.

31. The method of claim 1 further comprising monitoring the step of determining identifying information.

32. The method of claim 1 further comprising monitoring the step of building a request.

33. The method of claim 1 further comprising monitoring the step of at least partially completing the request.

34. The method of claim 1 further comprising prioritizing the building of the request based on the identifying information.

35. The method of claim 1 further comprising prioritizing the at least partially completing the request based at least in part on the type of the work.

36. The method of claim 1 further comprising prioritizing the submitting of the request for process based at least in part on the type of work.

37. The method of claim 1 wherein the work is financial services work.

38. The method of claim 1 wherein the work is pension plan work.

39. A method of managing workflow comprising:
imaging paper documents from clients at a first location to create digital images, the images expressing at least one client instruction;
manually examining the digital images to determine a subtype;
automatically associating a plurality of information fields required to complete processing of the at least one client instruction based on the subtype by creating a request;
manually completing the information fields of the request; and
submitting the completed information fields for processing.

40. The method of claim 39 further comprising checking the step of manually completing the information fields of the request.

41. The method of claim 39 further comprising checking the step of manually examining the digital images to determine a subtype.

42. The method of claim 39 wherein the subtype is selected from a list of standardized processes.

43. A new method of processing correspondence from clients in a financial product administration system having the advantages of standardized workflows and balanced work loads, the method comprising:
receiving the client contact;
routing the client contact to a request examiner for evaluation;
selecting at least one of a list of standardized processes for the client;
creating a request based upon the selected standardized process;
placing the request in a working queue of current requests; and
assigning to an available worker one of the current requests based upon priority of the request and a skill level of the worker.

44. The method of claim 43 wherein the one of the current requests is assigned to the worker having the lowest skill level qualified for the request.

45. The method of claim 43 wherein the working queue of current requests is a queue for requests based on location.

46. The method of claim 43 further comprising the step of working the assigned request by the worker.

47. The method of claim 46 further comprising the step of completing the assigned request.

48. The method of claim 47 further comprising the step of storing the completed request in a database to await cycle processing.

49. The method of claim 48 wherein the completed request is routed to a quality control destination.

50. The method of claim 43 further comprising the step of capturing system information concerning the amount of work performed for different requests and skill levels.

51. The method of claim 43 further comprising the step of reporting the system information.

52. The method of claim 43 further comprising the step of assigning the customer correspondence an identification number for tracking the correspondence and associated one or more requests throughout the system.

53. A new method of processing correspondence from customers having the advantage of balancing and leveraging workforces from remote locations, the method comprising:
defining a plurality of standardized processes;
providing two or more workforces of workers in different locations;
providing a computer network connecting the two or more workforces;
providing a request examiner in at least one of the locations;
defining a plurality of skill levels for the workers;
assigning each of the workers at least one of the skill levels;
receiving the customer correspondence;
routing the customer correspondence to a request examiner in one of the locations for evaluation;
selecting at least one of the standardized processes for the customer correspondence;
creating a request based upon the selected standardized process, the request being associated with one of the skill levels;
storing the request in a working queue of current requests; and
assigning to a next available worker in one or more of the locations one of the current requests based upon priority of the request and the skill level of the worker.

54. The method of claim 54 wherein the one of the current requests is assigned to the worker having the lowest skill level qualified for the request.

55. The method of claim 54 wherein the request is assigned to the next available worker in any of the locations.
